(19) United States
(12) Patent Application Publication
(10) Pub. No.: US 2020/0401467 A1
(43) Pub. Date: Dec. 24, 2020

(54) MANAGEMENT AND CONTROL METHOD FOR APPLICATION, TERMINAL, AND STORAGE MEDIUM

(71) Applicant: ZTE CORPORATION, Shenzhen, Guangdong (CN)

(72) Inventor: Xiaorui LIU, Shenzhen (CN)

(73) Assignee: ZTE Corporation, Shenzhen, Guangdong (CN)

(21) Appl. No.: 16/643,620

(22) PCT Filed: Aug. 28, 2018
(86) PCT No.: PCT/CN2018/102747

§ 371 Date: Jul. 9, 2020

(30) Foreign Application Priority Data
Aug. 31, 2017 (CN) 201710768564.3

(51) Int. Cl. G06F 9/54; G06F 9/445

(52) U.S. Cl. CPC G06F 9/542; G06F 9/44505; G06F 9/546

(57) ABSTRACT

Provided are a management and control method for applications, a terminal, and a storage medium. The method includes: determining, according to a broadcast message received from an operating system, an identifier of a broadcast receiver corresponding to an identifier of the broadcast message; screening out at least one broadcast receiver declared by an application which has an identifier the same as the identifier of the broadcast receiver corresponding to the identifier of the broadcast message; and transmitting the broadcast message to a broadcast receiver in a reception-enabled state among the at least one broadcast receiver declared by the application, and performing management and control on the application corresponding to the broadcast receiver in the reception-enabled state.

### CROSS-REFERENCES TO RELATED APPLICATIONS

This is a National Stage Application, filed under 35 U.S.C. 371, of International Patent Application No. PCT/CN2018/102747, filed on Aug. 28, 2018, which claims priority to a Chinese patent application No. 201710768564.3 filed at the CNIPA on Aug. 31, 2017, disclosure of which is incorporated herein by reference in its entirety.

### TECHNICAL FIELD

The present disclosure relates to the field of communications and, for example, to an application management method, a terminal, and a storage medium.

### BACKGROUND

With the development of communication technologies, an intelligent terminal integrates more and more functions, so that a system function list of the intelligent terminal includes more and more applications (APPs), and a user can install various applications, such as related software applications of entertainment, work and life, on the intelligent terminal.

Many applications may automatically start in the process of starting or running of the intelligent terminal after the applications are installed, so that some behaviors which may not be perceived by users are performed, and a considerable danger exists. Most mainstream intelligent-terminal manufacturers in the market deeply customize a system-level management and control system for an application, but the management and control system either allows all background behaviors of applications or forbids all background behaviors of applications, that is, adopts a black-and-white list mechanism. However, for more and more applications, if background behaviors of the applications are completely forbidden, the applications would not run properly, and if the management and control is released, behaviors of the applications become uncontrolled.

Therefore, in the system-level management and control system for an application, no management and control measures which are more detailed than the system-level management and control system are provided to ensure the normal use of a certain application after the certain application is installed by a user or ensure that all behaviors of the certain application are within the perceivable range of the user.

### SUMMARY

The embodiments of the present disclosure provide an application management method, a terminal, and a storage medium. The application management method is performed in a more detailed manner than the system-level management and control system to ensure normal use of a certain application after the certain application is installed, and ensure that all behaviors of the certain application are within the perceivable range of the user.

The embodiments of the present disclosure provide an application management method. The method includes the steps described below.

According to a broadcast message received from an operating system, an identifier of a broadcast receiver corresponding to an identifier of the broadcast message is determined.

At least one broadcast receiver declared by an application which has an identifier the same as the identifier of the broadcast receiver corresponding to the identifier of the broadcast message is screened out.

The broadcast message is transmitted to a broadcast receiver in a reception-enabled state among the at least one broadcast receiver declared by the application, and a management for the application corresponding to the broadcast receiver in the reception-enabled state is performed.

The embodiments of the present disclosure provide a terminal. The terminal at least includes a processor and a storage medium configured to store executable instructions.

The processor is configured to execute the stored executable instructions. The executable instructions include the instructions described below.

According to a broadcast message received from an operating system, an identifier of a broadcast receiver corresponding to an identifier of the broadcast message is determined.

At least one broadcast receiver declared by an application which has an identifier the same as the identifier of the broadcast receiver corresponding to the identifier of the broadcast message is screened out.

The broadcast message is transmitted to a broadcast receiver in a reception-enabled state among the at least one broadcast receiver declared by the application, and a management for the application corresponding to the broadcast receiver in the reception-enabled state is performed.

The embodiments of the present disclosure provide a storage medium, which is configured to store computer-executable instructions for performing the application management method.

The management and control granularity of the application management method according to the embodiments of the present disclosure is a broadcast receiver. The method is more detailed than a management and control method using an application as granularity. The application management method using the broadcast receiver as granularity can ensure that all behaviors of the application are within the perceivable range of the user while ensuring that the application can be normally used. In this manner, the application is prevented from performing operation of damaging the data security of the user by monitoring the state change of a mobile phone at the background, and the data security of the user is improved.

### BRIEF DESCRIPTION OF DRAWINGS

FIG. 1 is a flowchart of an application management method according to one embodiment;

FIG. 2 is a schematic diagram showing an interface for configuring broadcast receivers according to one embodiment;

FIG. 3 is a schematic diagram showing an interface for configuring broadcast receivers according to another embodiment;

FIG. 4 is a flowchart of an application management method according to another embodiment;

FIG. 5 is a flowchart of an application management method according to another embodiment; and

FIG. 6 is a structural diagram of a terminal according to one embodiment.

### DETAILED DESCRIPTION

The technical solution disclosed will be described below with reference to the drawings in the embodiments of the present disclosure. The embodiments described below are intended to explain and not to limit the scope of the present disclosure.

For better understanding of the embodiments of the present disclosure, a broadcast mechanism of a terminal operating system, a broadcast receiver, and a registration method of the broadcast receiver will be described first.

The broadcast receiver is used for receiving and responding to a message broadcasted by a system. The broadcast mechanism is essentially a message subscription/publication mechanism. Therefore, a first step of using the message-driven model is to subscribe to a message. For applications, subscribing to a message is actually registering a broadcast receiver. After the system transmits the broadcast message, the system acquires the broadcast receiver corresponding to the broadcast message according to the registration condition, and then calls a processing function of the broadcast receiver at the application level to complete the processing of the broadcast message.

The process of registering the broadcast receiver by the application is a process of registering the broadcast receiver in an activity manager service (AMS). An application registers a broadcast receiver in the AMS by calling a registering-broadcast-receiver (e.g. registerReceiver) function of a context-function-wrapper (e.g. ContextWrapper) class. The broadcast receiver may be considered as a subclass of a broadcast-receiver (e.g. BroadcastReceiver) class, and the broadcast receiver is a software virtual entity.

Two methods for registering a broadcast receiver are a static registration method and a dynamic registration method.

The dynamic registration method, that is, registering and releasing a broadcast receiver by a function, is generally used for updating a state of a user interface (UI). Generally, the dynamic registration method is used for registering a BroadcastReceiver in a case where an activity starts. Once a broadcast event is received, a control in the current activity may be updated in an onReceive method. However, it is to be noted that if the activity is invisible, the registration is released by calling an unregisterReceiver method. Therefore, no message is received.

The activity is described herein. An activity represents a visible UI, which focuses on an event done by a user. For example, the activity may represent a menu item list selectable by the user, or may display a photo together with a title of the photo. A text messaging application may have a first activity in which a list of contacts information may be transmitted to is displayed; a second activity in which information is written to a selected contact; and other activities in which old information is re-viewed or a setting is changed. Although the activities work together to form an integrated UI, each of the activities is independent of other activities.

The static registration method is registering a broadcast receiver in an android application entry document (e.g. AndroidManifest.xml). The static registration method may ensure that the BroadcastReceiver is constantly in an active state after an application is installed. The method is generally used for monitoring the state change of the system, for example, a battery capacity of a mobile phone and a state of a wireless-fidelity (Wi-Fi) network card (of course, monitoring the state change also depends on the demand of a software). For the BroadcastReceiver, generally after a certain specified system event happens, corresponding operations are performed, for example, in a case where the Wi-Fi network card works, a cue message is provided to the user to prompt the user that the Wi-Fi network card works.

In the broadcast mechanism, a priority of the dynamic registration is higher than a priority of the static registration.

### Embodiment One

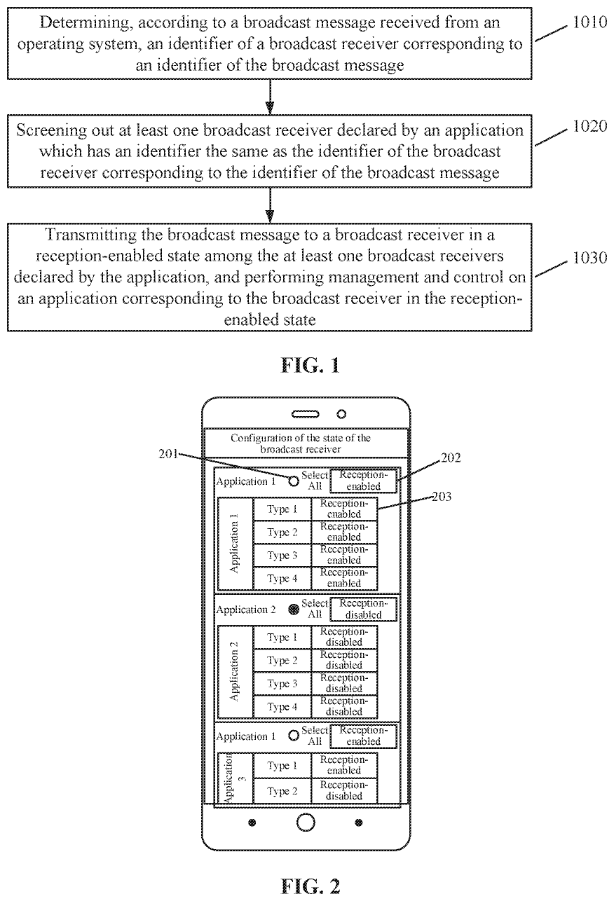

FIG. 1 is a flowchart of an application management method according to one embodiment. As shown in FIG. 1, the method includes the steps described below.

In step 1010, according to a broadcast message received from an operating system, an identifier of a broadcast receiver corresponding to an identifier of the broadcast message is determined.

The step 1010 of determining, according to the broadcast message received from the operating system, the identifier of the broadcast receiver corresponding to the identifier of the broadcast message may be performed by a terminal. The terminal may be a touch-operation-performable mobile phone (e.g. a telephone), a tablet computer (e.g. iPad) or a laptop or other mobile terminals with wireless communications capability. In one embodiment, the step 1010 of receiving the broadcast message transmitted by the operating system may be performed by a service (or process) on the terminal. The service may be an AMS run in an system process. The AMS is used for managing registration, transmitting, scheduling and processing of the broadcast message.

Content of the broadcast message may be data information closely related to an application, or may be Android system information, for example, change of network connection, change of battery capacity, or change of received short messages or system settings. If the application registers a BroadcastReceiver, specified broadcast information may be received. If a running state of the terminal changes, for example, in cases where change between a power-on state and a power-off state, change of time, low battery capacity or change between plugged-in and plugged-out of a universal serial bus (USB) happens, the operating system of the terminal transmits corresponding broadcast messages according to the running-state change of the terminal.

The broadcast message at least includes an identifier of the broadcast message. For example, the identifier of the broadcast message may be a type of the broadcast message.

Because one type of broadcast receivers receives one type of broadcast messages, a correspondence between broadcast receivers and broadcast messages exists in a registration list. After the broadcast message is received, the AMS acquires, according to an identifier of the broadcast message, an identifier of a broadcast receiver of a corresponding application on the terminal from the registration list. The identifier of the broadcast receiver at least includes the type of the broadcast receiver.

In step 1020, at least one broadcast receiver declared by an application which has an identifier the same as the identifier of the broadcast receiver corresponding to the identifier of the broadcast message is screened out.

The application may be an application installed and running on the terminal. Of course, the application may also be all applications installed on the terminal. One application may declare a plurality of broadcast receivers. Here what is to be determined is a broadcast receiver having an identifier the same as the identifier of the broadcast receiver corresponding to the identifier of the broadcast message, that is, a broadcast receiver able to receive and process the broadcast message.

In step 1030, the broadcast message is transmitted to a broadcast receiver in a reception-enabled state among the at least one broadcast receiver declared by the application, and a management for the application corresponding to the broadcast receiver in the reception-enabled state is performed.

A state of the broadcast receiver includes the reception-enabled state and a reception-disabled state. If one broadcast receiver is in the reception-enabled state, the corresponding broadcast message may be transmitted to the broadcast receiver. If one broadcast receiver is in the reception-disabled state, the corresponding broadcast message cannot be transmitted to the broadcast receiver. During implementation, a correspondence between the identifier of the broadcast receiver and the state of the broadcast receiver may be queried so that the state of the broadcast receiver is determined.

In the present embodiment, after the broadcast receiver in the reception-enabled state among the at least one broadcast receiver declared by the application receives the broadcast message, corresponding processing is performed according to the broadcast message. For example, if the broadcast message of time changing and time refreshing is received, the broadcast receiver enabled to receive the broadcast message updates the time according to the received broadcast message.

In other embodiments, before step 1030, the method further includes the steps described below. Whether the at least one broadcast receiver declared by the application which has an identifier the same as the identifier of the broadcast receiver corresponding to the identifier of the broadcast message is in the reception-enabled state is determined. If the broadcast receiver is in the reception-enabled state, step 1030 is performed. If the broadcast receiver is in the reception-disabled state, the process ends.

In other embodiments, the method further includes that identifiers and current states of the broadcast receivers declared by the application are acquired and output; a first operation instruction for a user to configure the states of the broadcast receivers is received and the states of the broadcast receiver are configured according to the first operation instruction.

In a case where the terminal is in a starting state, after the user enters, through a touch operation, an interface for configuring states of broadcast receivers, full-disk scanning may be performed on installed applications through a package manager service (e.g. PackagemanagerService), and identifiers and current states of broadcast receivers declared by all applications are acquired and output for the user to preform configuration. In this manner, the user may perform management and control of the broadcast receivers declared by the applications according to the demand of the user and a current state of the terminal.

In the present embodiment, according to a broadcast message received from an operating system, an identifier of a broadcast receiver corresponding to an identifier of the broadcast message is determined. At least one broadcast receiver declared by an application which has an identifier the same as the identifier of the broadcast receiver corresponding to the identifier of the broadcast message is screened out. The broadcast message is transmitted to a broadcast receiver in a reception-enabled state among the at least one broadcast receiver declared by the application, and a management for the application corresponding to the broadcast receiver in the reception-enabled state is performed. In this manner, only in a case where the broadcast receiver declared by the application is in the reception-enabled state, the broadcast message is transmitted to the broadcast receiver. That is, the management and control granularity of the application management method according to the present embodiment is a broadcast receiver. The method is more detailed than a management and control method using an application as granularity. Furthermore, because the state of the broadcast receiver is configured by the user, the application management method using the broadcast receiver as granularity can ensure that all behaviors of the application are within the perceivable range of the user while ensuring that the application can be normally used. In this manner, the application is prevented from performing operation of damaging the data security of the user by monitoring the state change of the terminal at the background, and the data security of the user is improved.

### Embodiment Two

Based on the preceding embodiment, the present embodiment provides an application management method, which is applied to the terminal. The method includes the steps described below.

In step 10, identifiers and states of the broadcast receivers declared by the applications installed on the terminal are acquired and output.

In the present embodiment, in a case where the user enters a configuration interface of the broadcast receivers declared by applications installed on the terminal, a service process on the terminal scans the broadcast receivers declared by the installed applications, and identifiers and current states of all the broadcast receivers are acquired and output. In a case where the identifiers and the states of the broadcast receivers are output, the identifiers and the states of the broadcast receivers may be output according to identifiers of the applications, or the identifiers and the states of the broadcast receivers may be output according to the identifiers of the broadcast receivers.

In step 20, a first operation instruction for a user to configure the states of the broadcast receivers is received and the states of the broadcast receivers are configured according to the first operation instruction.

In the present embodiment, because a large number of applications are installed on the terminal, each application declares a plurality of broadcast receivers. For example, 15 applications are installed on the terminal, and the number of broadcast receivers declared by each application may be same or different. It is assumed that the average number of broadcast receivers declared by each application is 5. In this manner, the number of the output broadcast receivers is 75, which is a great number for the user. To make a subscriber configure the broadcast receivers in a more convenient and rapider manner according to the demand of the subscriber, a plurality of configuration manners are provided for the user. In a case where the number of broadcast receivers which need to be configured by the user is relatively small, the states of the broadcast receivers may be configured one by one. In a case where the number of broadcast receivers which need to be configured by the user is relatively great and the states of broadcast receivers of a certain application or of a certain type are configured uniformly, an interface to perform configuration uniformly according to types of the broadcast receivers or an identifier of the application is provided to the user.

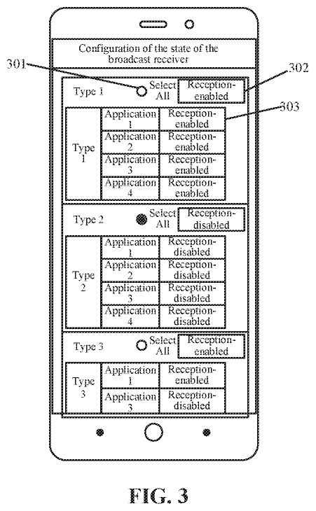

FIG. 2 is a schematic diagram showing an interface for configuring broadcast receivers according to one embodiment. As shown in FIG. 2, in the configuration interface of the broadcast receivers, an interface 201 for configuration of all broadcast receivers declared by one application is provided. In a case where the user selects “Select All” in the interface 201, states of all the broadcast receivers declared by application 1 may be configured in area 202. If the user does not select the interface 201, the state of each broadcast receiver may be configured separately in a column where area 203 is located.

FIG. 3 is a schematic diagram showing an interface for configuring broadcast receivers according to another embodiment. As shown in FIG. 3, in the configuration interface of the broadcast receivers, an interface 301 for configuration of broadcast receivers belonging to a same type is provided. In a case where the user selects “Select All” in the interface 301, states of all the broadcast receivers belonging to type 1 may be configured in area 302. If the user does not select the interface 301, the state of each broadcast receiver may be configured separately in a column where area 303 is located.

In step 30, a broadcast message from an operating system of the terminal is received.

In step 40, according to an identifier of the broadcast message, an identifier of a broadcast receiver corresponding to the broadcast message is determined.

In step 50, a first broadcast receiver set having identifiers the same as the identifier of the broadcast receiver is determined.

The first broadcast receiver set includes at least one broadcast receiver declared by an application on the terminal.

In step 60, broadcast receivers in a reception-enabled state among the first broadcast receiver set are determined to be included in a second broadcast receiver set.

In step 70, the broadcast message is transmitted to the broadcast receiver in the second broadcast receiver set, and management and control of an application corresponding to the broadcast receiver in the second broadcast receiver set is performed.

In other embodiments, the identifier of the broadcast receiver at least includes a type of the broadcast receiver. Correspondingly, the steps in which the identifiers and the states of the broadcast receivers of applications installed on the terminal are acquired and output include the steps described below.

The types and the states of the broadcast receivers of the applications installed on the terminal are acquired. Types and states of broadcast receivers belonging to a same application are outputted according to an identifier of the application. Optionally, types and states of broadcast receivers belonging to a same type of broadcast receivers and belonging to different applications are outputted according to the types of the broadcast receivers.

In other embodiments, in a case where the types and the states of the broadcast receivers belonging to a same application are output according to the identifier of the application, the steps in which a first operation instruction for the user to configure the states of the broadcast receivers is received and the state of the broadcast receiver is configured according to the first operation instruction include that the first operation instruction for the user to configure the states of the broadcast receivers is received; in condition that the first operation instruction is used for configuring a state of one broadcast receiver, then a type of a to-be-configured broadcast receiver and an identifier on the application to which the to-be-configured broadcast receiver belongs are determined according to the first operation instruction, and the state of the to-be-configured broadcast receiver declared by the application is configured according to the determined type of the to-be-configured broadcast receiver, the determined identifier of the application and the first operation instruction; in condition that the first operation instruction is used for configuring the states of the broadcast receivers belonging to the same application, then the identifier of the target application to which the to-be-configured broadcast receivers belong is determined according to the first operation instruction, and the states of all the broadcast receivers declared by the target application are configured according to the determined identifier of the target application and the first operation instruction.

That is, in a case where output identifiers and the output types of the broadcast receivers are successively arranged according to broadcast receivers declared by a same application, the user may configure individual broadcast receiver. For example, the user may switch the state of a time-refreshing broadcast receiver declared by a certain weather forecast application to the reception-enabled state, and switch the state of a data-refreshing broadcast receiver declared by the certain weather forecast application to the reception-disabled state. In this manner, the weather forecast application updates only the time and does not update the data. Thus, normal use of the weather forecast application is ensured and great waste of battery capacity and data traffic due to data update is avoided. Likewise, if the user does not want the weather forecast application to run at the background, the user may switch the states of all the broadcast receivers declared by the weather forecast application to the reception-disabled state.

In other embodiments, in a case where the types and the states of the broadcast receivers belonging to a same type of broadcast receivers and belonging to different applications are output according to the types of the broadcast receivers, the steps in which the first operation instruction for the user to configure the states of the broadcast receivers is received and the state of the broadcast receiver is configured according to the first operation instruction include that the first operation instruction for the user to configure the states of the broadcast receivers is received; if the first operation instruction is used for configuring a state of one broadcast receiver, then a type of the to-be-configured broadcast receiver and an identifier on the application to which the to-be-configured broadcast receiver belongs are determined according to the first operation instruction, and the state of the to-be-configured broadcast receiver is configured according to the determined type of the to-be-configured broadcast receiver, the determined identifier of the application and the operation instruction; if the first operation instruction is used for configuring states of broadcast receivers of a same type, then the type of the to-be-configured broadcast receivers are determined according to the first operation instruction, and states of all the broadcast receivers of the same type as the type of the to-be-configured broadcast receivers are configured according to the determined type of the to-be-configured broadcast receivers and the first operation instruction.

Likewise, in a case where output identifiers and the output states of the broadcast receivers are successively arranged according to the type of the broadcast receivers, the user may configure individual broadcast receiver. For example, if the user wants to update the data only in an instant-communication application, and does not want to update the data in an weather forecast application, the user may switch the state of a data-update broadcast receiver declared by the weather forecast application to the reception-disabled state, and switch the state of a data-update broadcast receiver declared by the instant-communication application to the reception-enabled state. Likewise, if since the terminal has a low battery or is not connected to a Wi-Fi network, the user wants all applications not to perform data update, then the user may switch the states of data-update broadcast receives to the reception-disabled state.

In other embodiments, the steps in which the state of the to-be-configured broadcast receiver is configured according to the determined type of the to-be-configured broadcast receiver, the determined identifier of the application and the first operation instruction include the steps described below.

In condition that the first operation instruction is used for switching the state of the to-be-configured broadcast receiver to a reception-disabled state from a reception-enabled state, the state of the to-be-configured broadcast receiver is switched to the reception-disabled state from the reception-enabled state according to the first operation instruction. Cue information about an impact caused by switching the state of the to-be-configured broadcast receiver to the reception-disabled state is generated and output. In condition that a second operation instruction sent by the user to confirm that the state of the to-be-configured broadcast receiver is to be switched to the reception-disabled state is not received, the state of the to-be-configured broadcast receiver is switched to the reception-enabled state from the reception-disabled state.

In one embodiment, if the second operation instruction sent by the user to confirm that the state of the to-be-configured broadcast receiver is to be switched to the reception-disabled state is received, the state of the to-be-configured broadcast receiver is kept as the reception-disabled state according to the second operation instruction.

In the present embodiment, the states of the broadcast receivers declared by the application may be configured by the user. However, for some specified broadcast receivers, if the states of the broadcast receivers are switched to the reception-disabled state, the application may be unavailable. Therefore, in a case where the user switches the states of the broadcast receivers to the reception-disabled state, cue information is output. The user may refer to the cue information to decide whether to insist on switching the states of the broadcast receivers to the reception-disabled state.

In other embodiments, in a case where a new application is installed, states of broadcast receivers declared by the new application are configured. During implementation, the steps are as follows: after it is detected that a new application is installed, identifiers and states of broadcast receivers declared by the new application are acquired and output; a third operation instruction for a user to configure the states of the broadcast receivers declared by the new application are received, and the states of the broadcast receivers declared by the new application are configured according to the third operation instruction. In this manner, in a case where a new application is installed, the states of the broadcast receivers declared by the new application are configured before the uniform configuration is performed by the user. Therefore, management and control of the new application may be performed in time.

The explanation of the same steps or concepts in the present embodiment as in other embodiments can refer to the description in other embodiments.

In the present embodiment, the terminal configures the state of the broadcast receiver according to the operation instruction for the user to configure the states of the broadcast receivers. After the broadcast message from the operating system of the terminal is received, the identifier of the broadcast receiver declared by the corresponding application on the terminal is determined according to the identifier of the broadcast message. The first broadcast receiver set having an identifier the same as the identifier of the broadcast receiver is determined. The broadcast receivers in the reception-enabled state among the first broadcast receiver set are determined to be included in the second broadcast receiver set. The broadcast message is transmitted to the broadcast receiver in the second broadcast receiver set, and management and control of the application is performed. In this manner, only in a case where the state of the broadcast receiver declared by the application is the reception-enabled state, the broadcast message is transmitted to the broadcast receiver. That is, the management and control granularity of the application management method according to the present embodiment is a broadcast receiver. The method is more detailed than a management and control method using an application as granularity. Furthermore, because the state of the broadcast receiver is configured by the user, the application management method using the broadcast receiver as granularity can ensure that all behaviors of the application are within the perceivable range of the user. In this manner, the application is prevented from performing operation of damaging the data security of the user by monitoring the state change of the terminal at the background, and the data security of the user is improved.

### Embodiment Three

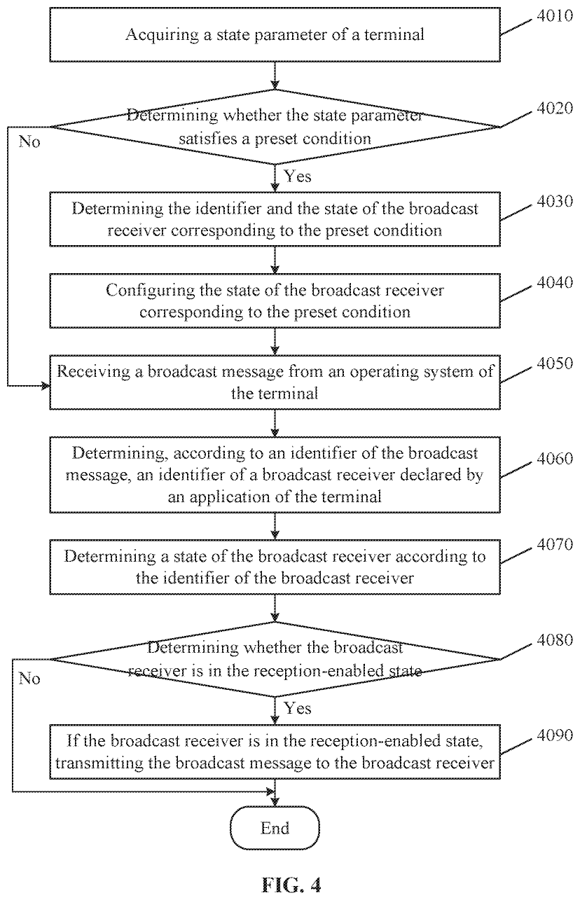

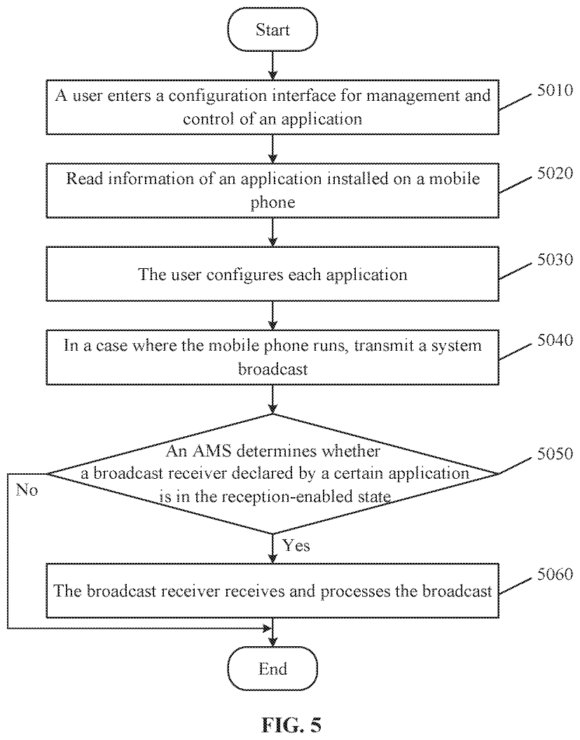

FIG. 4 is a flowchart of an application management method according to another embodiment. As shown in FIG. 4, the method includes the steps described below.

In step 4010, a state parameter of a terminal is acquired.

In the present embodiment, the state parameter may be, for example, current battery capacity of the terminal, current network environment and current network state of the terminal, or current remaining data traffic in a subscriber identification module (SIM) on the terminal.

During implementation, the acquisition of the state parameter of the terminal may be performed in a real-time and constant manner, or be performed in periodical manner with certain time intervals.

In step 4020, whether the state parameter satisfies a preset condition is determined.

The preset condition is a condition for automatically configuring a broadcast receiver of an application installed on the terminal. During implementation, the preset condition may be as follows: the current battery capacity of the terminal is lower than a first preset value, the terminal is in a certain preset network or the current remaining data traffic in the SIM on the terminal is lower than a second preset value. For example, the preset condition may be as follows: the current battery capacity of the terminal is lower than 10% of the maximum battery capacity, the terminal is in a Wi-Fi network or the current remaining data traffic in the SIM card on the terminal is lower than 10 Megabytes (M).

If the state parameter satisfies the preset condition, step 4030 is performed. If the state parameter does not satisfy the preset condition, step 4050 is performed.

In step 4030, the identifier and the state of the broadcast receiver corresponding to the preset condition are determined.

In the present embodiment, the terminal stores the identifier and the state of the to-be-configured broadcast receiver corresponding to the preset condition in a case where the state parameter of the terminal satisfies a certain preset condition. For example, in a case where the current battery capacity of the terminal is lower than 10% of the maximum battery capacity, the state of the broadcast receiver for the mobile data connection on the terminal is switched to a reception-disabled state, and the state of the broadcast receiver for the wireless data connection is switched to the reception-disabled state. As another example, in a case where the terminal is in the Wi-Fi network, the state of the broadcast receiver for the wireless data connection is switched to a reception-enabled state.

In one embodiment, the identifier and the state of the broadcast receiver corresponding to the preset condition may be preset by a user. In this manner, the intelligence of the terminal can be increased, and the background behavior of the application installed on the terminal can be ensured to be within the perceivable range of the user.

In step 4040, the state of the broadcast receiver corresponding to the preset condition is configured.

In the present embodiment, during configuration of the state of the broadcast receiver corresponding to the preset condition, the current state of the to-be-configured broadcast receiver is determined, and comparison between the current state of the to-be-configured broadcast receiver and the to-be-configured state of the to-be-configured broadcast receiver is performed. If the current state of the to-be-configured broadcast receiver is the same as the to-be-configured state of the to-be-configured broadcast receiver, no process is performed. If the current state of the to-be-configured broadcast receiver is different from the to-be-configured state of the to-be-configured broadcast receiver, the state of the to-be-configured broadcast receiver is switched to the to-be-configured state.

In step 4050, a broadcast message from an operating system of the terminal is received.

In step 4060, according to an identifier of the broadcast message, an identifier of a broadcast receiver declared by an application on the terminal is determined.

In step 4070, a state of the broadcast receiver is determined according to the identifier of the broadcast receiver.

In step 4080, whether the broadcast receiver is in the reception-enabled state is determined.

In the present embodiment, if the broadcast receiver is in the reception-enabled state, step 4090 is performed. If the broadcast receiver is in the reception-disabled state, the process ends.

In step 4090, the broadcast message is transmitted to the broadcast receiver.

In other embodiments, the method further includes that whether a switch for automatically configuring the broadcast receiver is on or off is determined; if the switch for automatically configuring the broadcast receiver is on, step 4010 is performed; if the switch for automatically configuring the broadcast receiver is off, step 4050 is performed.

In the present embodiment, in a case where the switch for automatically configuring the broadcast receiver is turned on, the terminal acquires the state parameter of the terminal. Meanwhile, in a case where the state parameter satisfies a certain preset condition, automatic configuration of states of some broadcast receivers is performed according to a correspondence preset by the user. After the broadcast message from the operating system of the terminal is received, the identifier of the broadcast receiver declared by the application on the terminal is determined according to the identifier of the broadcast message. The state of the broadcast receiver is determined according to the identifier of the broadcast receiver. If the broadcast receiver is in the reception-enabled state, the broadcast message is transmitted to the broadcast receiver. In this manner, only in a case where the broadcast receiver declared by the application is in the reception-enabled state, the broadcast message is transmitted to the broadcast receiver. That is, the management and control granularity of the application management method according to the present embodiment is also a broadcast receiver. The method is more detailed than a management and control method using an application as granularity. The state of the broadcast receiver is automatically configured according to a preset configuration of the user. The intelligence of the terminal can be increased, and all behaviors of the application can be ensured to be within the perceivable range of the user. In this manner, the application is prevented from performing operation of damaging the data security of the user by monitoring the state change of the terminal at the background, and the data security of the user is improved.

### Embodiment Four

The present embodiment provides an application management method. The method is mainly targeted at a case where after a user installs applications, dynamic management and control of the broadcast receivers declared by the applications is performed. The broadcast receivers declared by each application installed by the user are listed for the user to perform configuration.

In the present embodiment, the user may configure states of the broadcast receivers declared by all the installed applications in a specific configuration interface. Through enabling or disabling some broadcast receivers declared by the applications, the user may control background behaviors of the applications.

For applications installed by the user, in a case where the terminal starts, full-disk scanning is performed on the installed applications through a PackagemanagerService. Traversal of all the applications is performed. The broadcast receivers declared by all the applications are extracted for display and use in the configuration interface.

In a case where for a certain application, the user configures the state of a certain broadcast receiver of the application, after the user clicks “Confirm” in the configuration interface, according to the state of the broadcast receiver configured by the user, corresponding operation is performed on a component related to the broadcast receiver. For example, in a case where the user switches the state of the broadcast receiver to a reception-disabled state, a disable interface of the PackageManagerService is called through a component corresponding to the broadcast receiver and the component related to the broadcast receiver is disabled. In a case where the user switches the state of the broadcast receiver to a reception-enabled state, an enable interface of the PackageManagerService is called through the component corresponding to the broadcast receiver and the component related to the broadcast receiver is enabled.

FIG. 5 is a flowchart of an application management method according to another embodiment. As shown in FIG. 5, the method includes the steps described below.

In step 5010, the user enters a configuration interface for management and control of an application.

In a case where the terminal starts, the user may enter, through touch operation, the configuration interface for management and control of an application. Optionally, in a case where the user installs a new application, the user enters the configuration interface for management and control of an application.

In step 5020, in the configuration interface for management and control of an application, information of an application installed by the user is acquired.

The information of an application installed by the user includes identifiers and the states of the broadcast receivers declared by the applications installed by the user. During implementation, the broadcast receivers declared by each application installed by the user are listed through scanning of the PackageManagerService. That is, the broadcast receivers are output in the configuration interface for management and control of an application.

In step 5030, the user configures the broadcast receivers of each application.

In step 5040, in condition that the state of the terminal changes between a power-on state or a power-off state, or the terminal runs, due to the state change, a system broadcast is transmitted.

In step 5050, in condition that the system transmits the system broadcast and the system broadcast needs to be distributed by an AMS, the AMS performs determination through reading a configuration result in the configuration interface.

The AMS determines whether a broadcast receiver corresponding to the system broadcast declared by a certain application is in the reception-enabled state. If the broadcast receiver corresponding to the system broadcast declared by the application is in the reception-enabled state, and the broadcast receiver wants to receive the system broadcast, then the AMS transmits the system broadcast to the broadcast receiver. If the broadcast receiver correspond to the system broadcast declared by the application is in the reception-disabled state, the process ends. In step 5060, the broadcast receiver receives and processes the system broadcast.

In the present embodiment, in a case where the state of the terminal changes when the terminal is switched to the power-on state or the terminal runs, and the system broadcast is transmitted, according to the configuration result of the user in the configuration interface, the AMS determines whether a broadcast receiver declared by a certain application may receive the system broadcast of the system. If the broadcast receiver declared by the application is disabled by the user, that is, the broadcast receiver declared by the application is in the reception-disabled state, the broadcast receiver of the application is forbidden to receive the broadcast. Therefore, certain applications are prevented from performing certain operations by monitoring the state change of the terminal at the background, and the data security of the terminal user is ensured.

### Embodiment Five

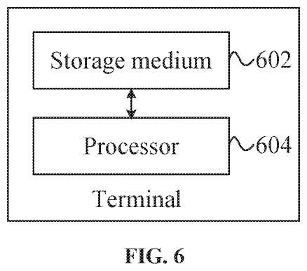

FIG. 6 is a structural diagram of a terminal according to one embodiment. As shown in FIG. 6, the terminal 600 includes a processor 601 and a storage medium 602 configured to store executable instructions. The processor 601 is configured to execute the stored executable instructions. The executable instructions include that according to a broadcast message received from an operating system, an identifier of a broadcast receiver corresponding to an identifier of the broadcast message is determined; at least one broadcast receiver declared by an application which has an identifier the same as the identifier of the broadcast receiver corresponding to the identifier of the broadcast message is screened out; the broadcast message is transmitted to a broadcast receiver in a reception-enabled state among the at least one broadcast receiver declared by the application, and a management for the application corresponding to the broadcast receiver in the reception-enabled state is performed.

In other embodiments, the processor 601 is configured to execute the stored executable instructions, and the executable instructions further include the instructions described below.

Identifiers and states of the broadcast receivers declared by the application are acquired and received.

A first operation instruction for a user to configure the states of the broadcast receivers is received and the states of the broadcast receiver are configured according to the first operation instruction.

In other embodiments, the identifier of the broadcast receiver at least includes a type of the broadcast receiver. Correspondingly, in condition that the types and the states of the broadcast receivers belonging to a same type of broadcast receivers and belonging to different applications are outputted according to the types of the broadcast receivers, the steps in which a first operation instruction for the user to configure the states of the broadcast receivers are received and the state of the broadcast receiver are configured according to the first operation instruction include that the first operation instruction for the user to configure the states of the broadcast receivers is received; in condition that the first operation instruction is used for configuring a state of one broadcast receiver, then a type of the to-be-configured broadcast receiver and an identifier of an application to which the to-be-configured broadcast receiver belongs are determined according to the first operation instruction, and the state of the to-be-configured broadcast receiver is configured according to the determined type of the to-be-configured broadcast receiver, the determined identifier of the application and the first operation instruction; in condition that the first operation instruction is used for configuring states of broadcast receivers of a same type, then the type of the to-be-configured broadcast receivers are determined according to the first operation instruction, and states of the broadcast receivers of the same type as the type of the to-be-configured broadcast receivers are configured according to the determined type of the to-be-configured broadcast receivers and the first operation instruction.

In other embodiments, in condition that the types and the states of the broadcast receivers belonging to a same application are outputted according to the identifier of the application, the steps in which the first operation instruction for the user to configure the states of the broadcast receivers is received and the states of the broadcast receiver are configured according to the first operation instruction include that the first operation instruction for the user to configure the states of the broadcast receivers is received; in condition that the first operation instruction is used for configuring a state of one broadcast receiver, then a type of the to-be-configured broadcast receiver and an identifier of an application to which the to-be-configured broadcast receiver belongs are determined according to the first operation instruction, and the state of the to-be-configured broadcast receiver is configured according to the determined type of the to-be-configured broadcast receiver, the determined identifier of the application and the first operation instruction; in condition that the first operation instruction is used for configuring the states of the broadcast receivers belonging to a same application, then the identifier of the target application to which the to-be-configured broadcast receivers belong is determined according to the first operation instruction, and the states of the broadcast receivers declared by the target application are configured according to the determined identifier of the target application and the operation instruction.

In other embodiments, the steps in which the state of the to-be-configured broadcast receiver is configured according to the determined type of the to-be-configured broadcast receiver, the determined identifier of the application and the first operation instruction include the steps described below.

In condition that the first operation instruction is used for switching the state of the to-be-configured broadcast receiver to a reception-disabled state from a reception-enabled state, the state of the to-be-configured broadcast receiver is switched to the reception-disabled state from the reception-enabled state according to the first operation instruction. Cue information of an affect caused by switching the state of the to-be-configured broadcast receiver to the reception-disabled state is generated and output. In condition that a second operation instruction sent by the user to confirm that the state of the to-be-configured broadcast receiver is to be switched to the reception-disabled state is received, the state of the to-be-configured broadcast receiver is kept as the reception-disabled state according to the second operation instruction. If the second operation instruction sent by the user to confirm that the state of the to-be-configured broadcast receiver is to be switched to the reception-disabled state is not received, the state of the to-be-configured broadcast receiver is switched to the reception-enabled state from the reception-disabled state.

In other embodiments, the processor 601 is configured to execute the stored executable instructions. The executable instructions further include that a state parameter of a terminal is acquired; whether the state parameter satisfies a preset condition is determined, where the preset condition is a condition for automatically configuring a broadcast receiver declared by an application; if the state parameter satisfies the preset condition, the identifier and the state of the broadcast receiver corresponding to the preset condition are determined; according to the identifier and the state of the broadcast receiver corresponding to the preset condition, the state of the broadcast receiver corresponding to the preset condition is configured.

In other embodiments, the processor 601 is configured to execute the stored executable instructions. The executable instructions further include that a component related to the to-be-configured broadcast receiver is disabled.

In other embodiments, the processor is configured to execute the stored executable instructions. The executable instructions further include that after it is detected that a new application is installed, identifiers and states of broadcast receivers declared by the new application are acquired and output; a third operation instruction for a user to configure the states of the broadcast receivers declared by the new application is received, and the state of the broadcast receiver declared by the new application is configured according to the third operation instruction.

The present embodiment provides a computer storage medium, which is configured to store computer-executable instructions for performing the application management method according to other embodiments of the present disclosure.

It should be understood by those skilled in the art that the embodiments of the present disclosure may be provided as methods, systems or computer program products. Therefore, the present disclosure may adopt a hardware embodiment, a software embodiment, or a combination of hardware and software embodiments. In addition, the present disclosure may take the form of a computer program product implemented in one or more computer-usable storage media (including, but not limited to, a disk memory and an optical memory) that includes computer-usable program codes.

The present disclosure is described with reference to flowcharts and/or block diagrams of methods, apparatuses (or systems) and computer program products according to the embodiments of the present disclosure. It should be understood that computer program instructions may implement each flow and/or block in the flowcharts and/or the block diagrams and a combination of flows and/or blocks in the flowcharts and/or the block diagrams. These computer program instructions may be provided for a general-purpose computer, a special-purpose computer, an embedded processor or a processor of another programmable data processing device to produce a machine so that instructions executed by the computer or the processor of another programmable data processing device produce an apparatus for implementing functions designated in one or more flows in the flowcharts and/or one or more blocks in the block diagrams.

These computer program instructions may be stored in a computer-readable memory that can cause the computer or another programmable data processing device to operate in a particular manner so that the instructions stored in the computer-readable memory produce a manufactured product including an instructing apparatus. The instructing apparatus implements the functions designated in the one or more flows in the flowcharts and/or the one or more blocks in the block diagrams.

These computer program instructions may also be loaded onto a computer or another programmable data processing device so that a series of operation steps are performed on the computer or another programmable device to produce processing implemented by the computer.

Therefore, instructions executed on the computer or another programmable device provide steps for implementing the functions specified in one or more flows in the flowcharts and/or one or more blocks in the block diagrams.

The above are only embodiments of the present disclosure and are not intended to limit the scope of the present disclosure.

1. An application management method, comprising:
determining, according to a broadcast message received from an operating system, an identifier of a broadcast receiver corresponding to an identifier of the broadcast message;
screening out at least one broadcast receiver declared by an application which has an identifier the same as the identifier of the broadcast receiver corresponding to the identifier of the broadcast message; and
transmitting the broadcast message to a broadcast receiver in a reception-enabled state among the at least one broadcast receiver declared by the application, and performing a management and control for the application corresponding to the broadcast receiver in the reception-enabled state.

2. The method of claim 1, wherein before the determining, according to the broadcast message received from the operating system, the identifier of the broadcast receiver corresponding to the identifier of the broadcast message, the method further comprises:
acquiring and outputting identifiers and states of broadcast receivers declared by applications; and
receiving a first operation instruction for a user to configure the states of the broadcast receivers and configuring the states of the broadcast receivers according to the first operation instruction.

3. The method of claim 2, wherein the identifier of the broadcast receiver at least comprises a type of the broadcast receiver;
wherein the acquiring and outputting the identifiers and the states of the broadcast receivers declared by the applications comprises: acquiring types and the states of the broadcast receivers declared by the applications, and outputting types and states of broadcast receivers belonging to a same type of broadcast receivers and belonging to different applications according to the types of the broadcast receivers; and
wherein the receiving the first operation instruction for the user to configure the states of the broadcast receivers and configuring the states of the broadcast receivers according to the first operation instruction comprises: receiving the first operation instruction for the user to configure the states of the broadcast receivers;
in condition that the first operation instruction is used for configuring a state of one broadcast receiver, then determining, according to the first operation instruction, a type of a to-be-configured broadcast receiver and an identifier on the application to which the to-be-configured broadcast receiver belongs, and configuring the state of the to-be-configured broadcast receiver according to the determined type of the to-be-configured broadcast receiver, the determined identifier of the application and the first operation instruction; in condition that the first operation instruction is used for configuring states of the broadcast receivers of the same type, then determining a type of to-be-configured broadcast receivers according to the first operation instruction, and configuring the states of the broadcast receivers of the same type as the type of the to-be-configured broadcast receivers according to the determined type of the to-be-configured broadcast receivers and the first operation instruction.

4. The method of claim 2, wherein the identifier of the broadcast receiver at least comprises a type of the broadcast receiver;
wherein the acquiring and outputting the identifiers and the states of the broadcast receivers declared by the applications comprises: acquiring the types and the states of the broadcast receivers declared by the application, and outputting types and states of broadcast receivers belonging to a same application according to an identifier of the application; and
wherein the receiving the first operation instruction for the user for to configure the states of the broadcast receivers and configuring the states of the broadcast receivers according to the first operation instruction comprises: receiving the first operation instruction for the user to configure the states of the broadcast receivers;
in condition that the first operation instruction is used for configuring a state of one broadcast receiver, then determining, according to the first operation instruction, a type of a to-be-configured broadcast receiver and an identifier of an application to which the to-be-configured broadcast receiver belongs, and configuring the state of the to-be-configured broadcast receiver according to the determined type of the to-be-configured broadcast receiver, the determined identifier of the application and the first operation instruction; in condition that the first operation instruction is used for configuring the states of the broadcast receivers belonging to the same application, then determining an identifier of a target application to which to-be-configured broadcast receivers belong according to the first operation instruction, and configuring states of broadcast receivers declared by the target application according to the determined identifier of the target application and the first operation instruction.

5. The method of claim 3, wherein the configuring the state of the to-be-configured broadcast receiver according to the determined type of the to-be-configured broadcast receiver, the determined identifier of the application and the first operation instruction comprises:
in condition that the first operation instruction is used for switching the state of the to-be-configured broadcast receiver to a reception-disabled state from a reception-enabled state, switching the state of the to-be-configured broadcast receiver to the reception-disabled state from the reception-enabled state according to the first operation instruction, generating and outputting cue information about an impact caused by switching the state of the to-be-configured broadcast receiver to the reception-disabled state; and
in condition that a second operation instruction sent by the user to confirm that the state of the to-be-configured broadcast receiver is to be switched to the reception-disabled state is not received, switching the state of the to-be-configured broadcast receiver to the reception-enabled state from the reception-disabled state.

6. The method of claim 5, further comprising: in condition that the second operation instruction sent by the user to confirm that the state of the to-be-configured broadcast receiver is to be switched to the reception-disabled state is received, maintaining the state of the to-be-configured broadcast receiver as the reception-disabled state according to the second operation instruction.

7. The method of claim 1, further comprising:
acquiring a state parameter of a terminal; and
determining whether the state parameter satisfies a preset condition, wherein a correspondence exists between the preset condition and an identifier and a state of a broadcast receiver;
in condition that the state parameter satisfies the preset condition, determining the identifier and the state of the broadcast receiver corresponding to the preset condition, and configuring the state of the broadcast receiver corresponding to the preset condition according to the identifier and the state of the broadcast receiver corresponding to the preset condition.

8. The method of claim 5, wherein after the switching the state of the to-be-configured broadcast receiver to the reception-disabled state from the reception-enabled state according to the first operation instruction, the method further comprises:
disabling a component related to the to-be-configured broadcast receiver.

9. The method of claim 1, further comprising:
after detecting that a new application is installed, acquiring and outputting identifiers and states of broadcast receivers declared by the new application; and
receiving a third operation instruction for a user to configure the states of the broadcast receivers declared by the new application and configuring the states of the broadcast receivers declared by the new application according to the third operation instruction.

10. A terminal comprising at least a processor and a storage medium configured to store executable instructions, wherein the processor is configured to execute the stored executable instructions, and the executable instructions comprise:
determining, according to a broadcast message received from an operating system, an identifier of a broadcast receiver corresponding to an identifier of the broadcast message;
screening out at least one broadcast receiver declared by an application which has an identifier the same as the identifier of the broadcast receiver corresponding to the identifier of the broadcast message; and
transmitting the broadcast message to a broadcast receiver in a reception-enabled state among the at least one broadcast receiver declared by the application, and performing a management for the application corresponding to the broadcast receiver in the reception-enabled state.

11. A non-transitory computer storage medium, which is configured to store computer-executable instructions for performing the application management method of claim 1.

12. The method of claim 4, wherein the configuring the state of the to-be-configured broadcast receiver according to the determined type of the to-be-configured broadcast receiver, the determined identifier of the application and the first operation instruction comprises:
in condition that the first operation instruction is used for switching the state of the to-be-configured broadcast receiver to a reception-disabled state from a reception-enabled state, switching the state of the to-be-configured broadcast receiver to the reception-disabled state from the reception-enabled state according to the first operation instruction, generating and outputting cue information about an impact caused by switching the state of the to-be-configured broadcast receiver to the reception-disabled state; and
in condition that a second operation instruction sent by the user to confirm that the state of the to-be-configured broadcast receiver is to be switched to the reception-disabled state is not received, switching the state of the to-be-configured broadcast receiver to the reception-enabled state from the reception-disabled state.
